(19) United States
(12) Patent Application Publication
(10) Pub. No.: US 2025/0291481 A1
(43) Pub. Date: Sep. 18, 2025

(54) MEMORY SUB-SYSTEM WITH ZNS SHUTTLE BUFFERS

(71) Applicant: Micron Technology, Inc., Boise, ID (US)

(72) Inventor: Luca Bert, San Jose, CA (US)

(21) Appl. No.: 19/080,593

(22) Filed: Mar. 14, 2025

Related U.S. Application Data
(60) Provisional application No. 63/565,883, filed on Mar. 15, 2024.

(51) Int. Cl. G06F 3/06

(52) U.S. Cl. CPC G06F 3/0607; G06F 3/0656; G06F 3/0679

(57) ABSTRACT

The disclosure configures a memory sub-system controller to operate a memory sub-system using one or more shuttle buffers. The controller receives, from a host, a request to program a collection of data, the collection of data having a size corresponding to an individual unit size of an individual component of a set of memory components. The controller places the collection of data in an individual shuttle buffer of one or more shuttle buffers and stores the collection of data from the individual shuttle buffer to the individual component of the set of memory components without waiting for additional data to be received from the host.

### PRIORITY APPLICATION

This application claims the benefit of priority to U.S. Provisional Application Ser. No. 63/565,883, filed Mar. 15, 2024, which is incorporated herein by reference in its entirety.

### TECHNICAL FIELD

Examples of the disclosure relate generally to memory sub-systems and, more specifically, to operating the memory sub-systems using shuttle buffers.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components.

### BRIEF DESCRIPTION OF THE DRAWINGS

The present disclosure will be understood more fully from the detailed description given below and from the accompanying drawings of various examples of the disclosure.

FIG. 1 is a block diagram illustrating an example computing environment including a memory sub-system, in accordance with some examples.

FIG. 2 is a block diagram of an example architecture of shuttle buffers of the memory sub-system, in accordance with some examples.

FIG. 3 is a block diagram of an example a large indirection unit (IU) table, in accordance with some examples.

FIG. 4 is a block diagram of an example set of shuttle buffers, in accordance with some examples.

FIG. 5 is a flow diagram of an example method to operate a memory sub-system, in accordance with some examples.

FIG. 6 is a block diagram illustrating a diagrammatic representation of a machine in the form of a computer system within which a set of instructions can be executed for causing the machine to perform any one or more of the methodologies discussed herein, in accordance with some examples of the present disclosure.

### DETAILED DESCRIPTION

Examples of the present disclosure configure a system component, such as a memory sub-system controller (and/or host), to store a collection of data to one or more memory components (e.g., memory dies) using shuttle buffers. Specifically, the controller can receive from a host (e.g., an application) data that is pre-packaged by the host into a collection having a size that corresponds to (is the same as) the individual unit size of one of the memory components. This allows the controller to place the data directly into a shuttle buffer for storage in the memory component without having to wait for a specified amount of additional data. Namely, typically the controller receives data in smaller chunks from the host (e.g., individual pages each being 4 KB in size) and sequentially stores such smaller chunks of data in one buffer until a sufficient quantity is collected to form a block (e.g., 16 KB or 64 KB block) before placing the collection of data (e.g., the block of data) into a second buffer to be stored on the memory component. The disclosed controller allows the host to place the collection of data, that already has a size that matches the unit size (e.g., block size) of the memory component, directly in the shuttle buffer (e.g., the buffer that is used to program data to the memory component) without utilizing another buffer on the memory sub-system. This reduces the amount of resources needed to be consumed to store data to the memory sub-system and increases the scalability of the memory sub-system.

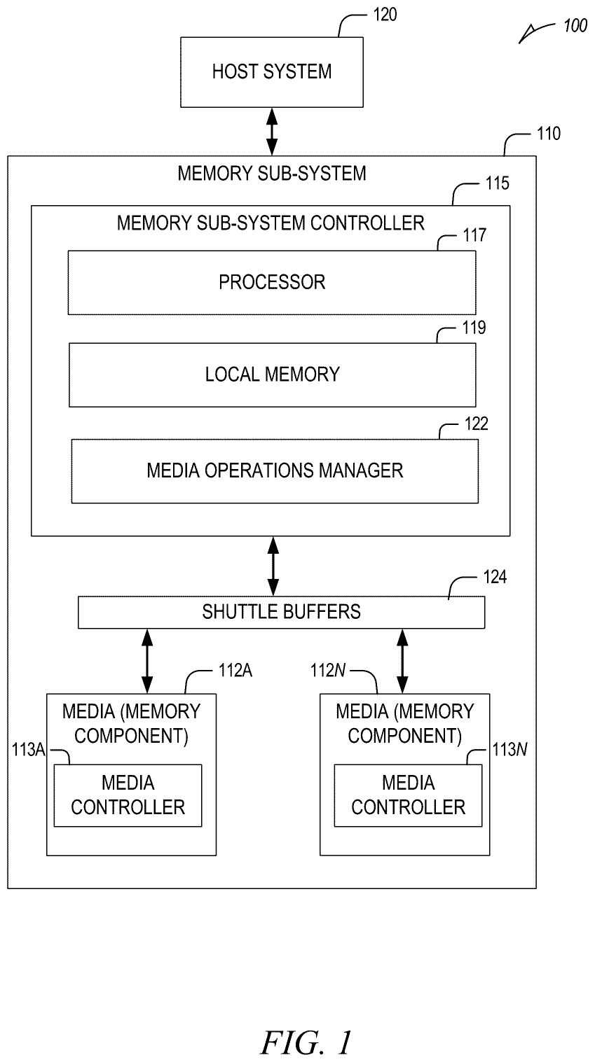

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices (e.g., memory dies or planes across multiple memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data.”

The memory sub-system can initiate media management operations (also referred to as backend operations), such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as “garbage collection data.” “User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, different read disturb management, different near miss error correction (ECC), and/or different dynamic data refresh. Wear leveling ensures that all blocks in a memory component approach their defined erase-cycle budget at the same time, rather than some blocks approaching it earlier. Read disturb management counts all of the read operations to the memory component. If a certain threshold is reached, the surrounding regions are refreshed. Near-miss ECC refreshes all data read by the application that exceeds a configured threshold of errors. Dynamic data-refresh scan reads all data and identifies the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., negative-and (NAND) devices), each plane is comprised of a set of physical blocks. For some memory devices, blocks are the smallest area than can be erased. Such blocks can be referred to or addressed as logical units (LUN). Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which include a raw memory device combined with a local embedded controller for memory management within the same memory device package.

New data layout methods are becoming quite pervasive in enterprise SSD space and the two forerunners are Zone Name Spaces (ZNS) and Flexible Data Placement (FDP). Both methods allow host to write data in different areas of SSD, called zones and regions respectively, and leave ample headroom for implementation in terms of what a zone/region is, how large is it, how many can be addressed in parallel, and so forth. The most problematic is for solutions that require a very large number of zones/regions to be written in parallel. The reason for this is that each zone/region available for writing requires a set of resources (cursor, memory buffers, context, and so forth) that is consuming the limited amount of resources available in the memory sub-systems. For example, current SSDs can easily handle up to 8/16 zones/regions for parallel writing but there are potential applications that require thousands and that is well beyond the capability of any SSD. Supporting a large number of zones/regions has both back-end and front-end impacts.

For example, memory buffers capacity is one physical limitation that is difficult to address for supporting very large numbers of zones/regions. For every writeable zone/region typical systems require a minimum of two write buffers whose capacity may be quite large. A first write buffer is used to collect data received from one or more applications until a specified data size (e.g., corresponding to a block size) is reached. At that point, the collected data is moved from the first write buffer to a second write buffer for storage on the block of the memory die or memory dies. In some cases, an 8 plane QLC NAND can require 8×4×16K=512 KB per buffer. So, two buffers would require 1 MB of storage. If there are 1,000 zones, the buffer required would need 1 GB of memory which is impractical to implement in SRAM and would compromise performance in DRAM. Another example of physical limitations of memory sub-systems in supporting very large numbers of zones/regions involves the protection against power loss. All of these buffers need to be protected in case of power loss. Power capacitors are used for this purpose and are capable of protecting a few 10's of MB and not at all the 1 GB needed. Region locking and adequate scalability of support structure for context management is another hurdle that needs to be addressed for supporting large numbers of zones/regions.

Some memory sub-systems use a large indirection unit (IU) as the flash translation layer (FTL) for managing the complex mapping between the logical addresses used by the host system and the physical addresses on the NAND flash memory. The indirection unit within the FTL is tasked with this address translation process, maintaining a mapping table or a similar data structure that correlates logical blocks to their corresponding physical blocks on the NAND flash. A “large” indirection unit involves mapping on a relatively coarse granularity. Instead of mapping at the level of individual pages, which would constitute a smaller indirection unit, a large indirection unit might map entire blocks or multiple pages together. This method can streamline the mapping process by reducing the complexity of the mapping table and minimizing the overhead typically associated with address translation, which can, in turn, enhance performance for certain types of workloads.

Examples of the present disclosure utilize large IUs to provide storage of very large numbers of zones/regions on the memory sub-system in a scalable and efficient manner. Specifically, the disclosed memory sub-system controller informs a host about the size of the IU of the memory components. The host performs operations for packaging data into a collection that has a size that matches the size of an individual IU. Then, the collection of data can be received from the host and stored directly in the shuttle buffers bypassing traditional buffers that are used to collect sufficient quantity of data on the memory controller. By placing the data received from the host directly to the shuttle buffers and then programming the data to the memory components, fewer storage resources are needed to support very large numbers of zones/regions. This is at least because half of the numbers of buffers are needed to program the data to the memory component.

Also, because there is no need to temporarily store data until a specified data size is reached for each zone/region, the number of buffers that are needed is substantially reduced. Namely, the number of buffers that are needed correspond to the maximum number of zones/regions that can be written in parallel at the same time rather than the number of zones/regions that are available in the memory sub-system. The host performs the per zone buffering operations and provides the data to the memory controller when a specified data size is reached (e.g., corresponding to the size of an individual IU that is stored by the large IU FTL). This reduces the amount of physical resources (e.g., buffering) that needs to be performed by the memory sub-system.

In some examples, the memory controller receives, from the host, a request to program a collection of data, the collection of data having a size corresponding to an individual unit size of an individual component of the set of memory components. The controller places the collection of data in an individual shuttle buffer of the one or more shuttle buffers. The controller stores the collection of data from the individual shuttle buffer to the individual component of the set of memory components without waiting for additional data to be received from the host.

The request can be received from a first application being executed by the host that is associated with a first namespace of a plurality of namespaces. The first namespace can be associated with a first portion of a logical address space corresponding to the set of memory components and a second namespace of the plurality of namespaces can be associated with a second portion of the logical address space corresponding to the set of memory components. The memory sub-system can include a solid-state drive.

In some examples, the collection of data is programmed to the individual component using a single buffer including the individual shuttle buffer without passing through any other buffers. The controller determines a maximum number of regions of the set of memory components that are programmable in parallel. The controller generates a quantity of shuttle buffers in the one or more shuttle buffers corresponding to the maximum number of regions of the set of memory components that are programmable in parallel. The collection of data can be received from the host in a particular arrangement and the collection of data is programmed to the individual component in the same particular arrangement.

The host can sequentially add portions of data associated with one or more applications to the collection of data to align the collection of data with the individual unit size of the individual component. In some cases, the host transmits the request to program the collection of data in response to determining that the collection of data has the size corresponding to the individual unit size of the individual component. In some cases, the individual unit size is greater than a 4 KB page size. The individual unit size can be 512 KB.

The controller maintains a set of large indirection units (IUs). The controller associate, in the set of large IUs, is an individual logical address received from the host with an individual unit of the individual component corresponding to the individual unit size that is greater than 4 KB. In some cases, the one or more shuttle buffers are implemented by SRAM or DRAM.

In some examples, the controller transmits, to the host, configuration information indicating the individual unit size of the individual component that is greater than 4 KB. The controller receives, from the host, an additional request to program a set of data. The controller determines that the set of data is smaller than the individual unit size of the individual component and, in response, retrieves a portion of data having a size corresponding to the individual unit size of the individual component. The controller modifies the retrieved portion of data using the set of data to generate a new portion of data having the set of data and being of the size corresponding to the individual unit size. The controller stores the new portion of data to the individual component. In some aspects, the controller transmits a confirmation of storage to the host in response to successfully programming the collection of data to the individual component.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing environment 100 including a memory sub-system 110, in accordance with some examples of the present disclosure. The memory sub-system 110 can include media, such as memory components 112A to 112N (also hereinafter referred to as “memory devices”). The memory components 112A to 112N can be volatile memory devices, non-volatile memory devices, or a combination of such. The memory components 112A to 112N can be implemented by individual dies, such that a first memory component 112A can be implemented by a first memory die (or a first collection of memory dies) and a second memory component 112N can be implemented by a second memory die (or a second collection of memory dies). Each memory die can include a plurality of planes in which data can be stored or programmed. In some cases, the first memory component 112A can be implemented by a first SSD (or a first independently operable memory sub-system) and the second memory component 112N can be implemented by a second SSD (or a second independently operable memory sub-system).

In some examples, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some examples, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL), a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe or CXL interface. The physical host interface can provide an interface for passing control, address, data, and other signals between the memory sub-system 110 and the host system 120.

The memory components 112A to 112N (which are used to implement the storage capabilities of the memory sub-system 110) can include any combination of the different types of non-volatile memory components and/or volatile memory components and/or storage devices. An example of non-volatile memory components includes a NAND-type flash memory. Each of the memory components 112A to 112N can include one or more arrays of memory cells such as single-level cells (SLCs) or multi-level cells (MLCs) (e.g., tri-level cells (TLCs) or quad-level cells [QLCs]). In some examples, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory. In some examples, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), negative-or (NOR) flash memory, electrically erasable programmable read-only memory (EEPROM), and a cross-point array of non-volatile memory cells.

A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages or blocks that can refer to an individual unit of the memory component 112 used to store data. For example, a single first row that spans a first set of the pages or blocks of the memory components 112A to 112N can correspond to or be grouped as a first block stripe and a single second row that spans a second set of the pages or blocks of the memory components 112A to 112N can correspond to or be grouped as a second block stripe. In some cases, the memory cells of one memory component 112A can be grouped as multiple memory pages or blocks that can refer to an individual unit of the memory component 112A used to store data. In such cases, a large indirection unit (e.g., large UI) can be used to associate a first logical address with a first group of memory pages or blocks of the memory component 112A and a second logical address with a second group of memory pages or blocks of the memory component 112A.

The memory sub-system controller 115 can communicate with the memory components 112A to 112N to perform memory operations such as reading data, writing data, or erasing data at the memory components 112A to 112N and other such operations. The memory sub-system controller 115 can communicate with the memory components 112A to 112N to perform various memory management operations (also referred to as back-end operations), such as different scan rates, different scan frequencies, different wear leveling, different read disturb management, garbage collection operations, different near miss ECC operations, and/or different dynamic data refresh.

The memory sub-system controller 115 can include hardware, such as one or more integrated circuits and/or discrete components, a buffer memory, or a combination thereof. The memory sub-system controller 115 can be a microcontroller, special-purpose logic circuitry (e.g., a field programmable gate array (FPGA), an application-specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some examples, the local memory 119 can include memory registers storing memory pointers, fetched data, and so forth. The local memory 119 can also include ROM for storing microcode. While the example memory sub-system 110 in FIG. 1 has been illustrated as including the memory sub-system controller 115, in another example of the present disclosure, a memory sub-system 110 may not include a memory sub-system controller 115, and can instead rely upon external control (e.g., provided by an external host, or by a processor 117 or controller separate from the memory sub-system 110).

In general, the memory sub-system controller 115 can receive commands or operations from the host system 120 and can convert the commands or operations into instructions or appropriate commands to achieve the desired access to the memory components 112A to 112N. In some examples, the commands or operations received from the host system 120 can specify configuration data for the memory components 112N to 112N. The configuration data can describe the lifetime (maximum) program-erase count (PEC) values and/or reliability grades associated with different groups of the memory components 112N to 112N and/or different blocks within each of the memory components 112N to 112N of each memory component used to implement the memory sub-system. For example, the memory sub-system may be made up of three memory components (e.g., three SSDs).

In some cases, the configuration data can specify namespace configuration data. For example, the host system 120 can instruct the memory sub-system controller 115 to generate a certain quantity of namespaces (associated with respective applications). In such cases, the configuration data can specify the logical block address (LBA) size of each namespace which can be the same or different from each other. The memory sub-system controller 115 can then generate a first namespace with a first set of LBAs (e.g., 0-100) and a second namespace with a second set of LBAs (e.g., 0-1000 or 100-1400). Each namespace can be assigned a unique identifier and that unique identifier corresponds to each application implemented by the host system 120.

The memory sub-system controller 115 receives a read/write request from the host system 120 including the unique identifier and a particular set of LBAs. The memory sub-system controller 115 identifies the corresponding namespace associated with the unique identifier and accesses an LBA map of the identified namespace to perform the memory operations being requested. This allows each application to operate as if it has its own memory sub-system 110. In some examples, the memory sub-system 110 includes one or more shuttle buffers 124. Data can be received from the host system 120 as a collection that corresponds to a size of an individual unit (e.g., spanning multiple pages or blocks) of one or more of the set of memory components 112A to 112N. The received collection of data can be placed in the one or more shuttle buffers 124. The one or more shuttle buffers 124 can then transfer the collection of data directly to one or more physical locations associated with a logical block address received from the host system 120 in association with the collection of data. Namely, rather than first storing the collection of data in one set of buffers and waiting for a specified quantity of additional data to be received to reach the size of the individual unit of the set of memory components 112A to 112N and then placing that set of data in another set of buffers, the memory sub-system controller 115 uses only a single buffer system that includes the one or more shuttle buffers 124.

The host system 120 can package a set of data on the host system 120 into a collection of data that has a sequence of data that is of a size corresponding to the individual unit of storage of the set of memory components 112A to 112N. The individual unit can be greater than a single page, such as greater than 4 KB (e.g., 16 KB, 32 KB, 64 KB, and so forth). Once the host system 120 completes assembling a collection of data that matches the size of the individual unit, the host system 120 sends a program request to the memory sub-system 110 to store the collection of data. The memory sub-system controller 115, in response, places the collection of data in the one or more shuttle buffers 124 for immediate storage in the set of memory components 112A to 112N without having to wait for additional data. Specifically, the memory sub-system controller 115 directly allows the host system 120 to store the data in the one or more shuttle buffers 124 for transfer to the set of memory components 112A to 112N without having to wait for additional data to be received. This increases the storage speed and efficiency of programming data to the set of memory components 112A to 112N. Once the data has successfully been programmed, the data can be cleared from the one or more shuttle buffers 124 and replaced with new data to be stored. Additionally, a confirmation command is sent to the host system 120 indicating successfully storage of the collection of data allowing the host system 120 to discard the data or perform other operations.

The memory sub-system controller 115 can be responsible for other memory management operations, such as wear leveling operations, garbage collection operations, error detection and ECC operations, encryption operations, caching operations, and address translations. The memory sub-system controller 115 can further include host interface circuitry to communicate with the host system 120 via the physical host interface. The host interface circuitry can convert the commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N.

The memory devices can be raw memory devices (e.g., NAND), which are managed externally, for example, by an external controller (e.g., memory sub-system controller 115). The memory devices can be managed memory devices (e.g., managed NAND), which is a raw memory device combined with a local embedded controller (e.g., local media controllers) for memory management within the same memory device package. Any one of the memory components 112A to 112N can include a media controller (e.g., media controller 113A and media controller 113N) to manage the memory cells of the memory component (e.g., to perform one or more memory management operations), to communicate with the memory sub-system controller 115, and to execute memory requests (e.g., read or write) received from the memory sub-system controller 115.

Depending on the example, the media operations manager 122 can comprise logic (e.g., a set of transitory or non-transitory machine instructions, such as firmware) or one or more components that causes the media operations manager 122 to perform operations described herein. The media operations manager 122 can comprise a tangible or non-tangible unit capable of performing operations described herein.

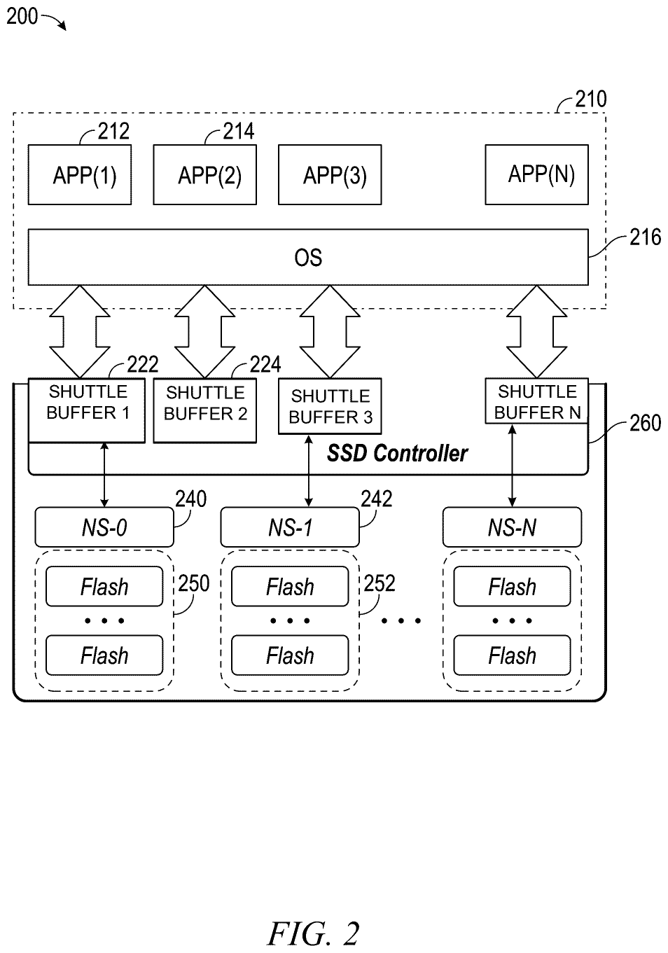

FIG. 2 is a block diagram of an example architecture 200 of shuttle buffers of the memory sub-system, in accordance with some examples. For example, an operating system 216 of a host system 210 can execute multiple applications, including a first application 212 and a second application 214. The operating system 216 can associate each application with a respective namespace on the memory sub-system 110. For example, the first application 212 can be associated with a first namespace 240 and corresponding set of memory components 250 (e.g., a first set of LBAs). The second application 214 can be associated with a second namespace 242 and corresponding set of memory components 252 (e.g., a second set of LBAs). In some cases, the same application can use multiple namespaces. In some cases, multiple applications can use the same namespace.

The SSD controller 260 (which corresponds to the memory sub-system controller 115) can manage the namespace allocation. In some cases, the SSD controller 260 can determine a maximum number of regions of the set of memory components (e.g., corresponding set of memory components 250 and corresponding set of memory components 252) that can be programed in parallel. For example, a single memory component may have multiple planes and can handle multiple write cursors. Such a memory component may be capable of programming two sets of data to two different physical locations in parallel. In such cases, the SSD controller 260 can generate two shuttle buffers (e.g., shuttle buffers 222 and 224) for programing data in parallel to the memory component. If there are 8 memory components each capable of performing two write operations in parallel, the SSD controller 260 can generate 16 shuttle buffers so that the host system 120 can program 16 different collections of data to the set of memory components 112A to 112N in parallel. Each shuttle buffer can be implemented by DRAM or SRAM external to the physical storage mechanism of the set of memory components 112A to 112N. The shuttle buffers can be implemented by the memory sub-system controller 115.

Each shuttle buffer can be associated with a different region or namespace of the memory components. In some cases, one shuttle buffer can service multiple namespaces on the same memory component. The SSD controller 260 can determine the size of the individual storage unit on the first namespace 240. For example, the SSD controller 260 can determine that the individual storage unit of the corresponding set of memory components 250 is 16 KB (e.g., 4 pages). In such cases, a single logical address can be associated with 16 KB of storage. The SSD controller 260 can generate the shuttle buffers associated with the first namespace 240 to be 16 KB wide (e.g., the shuttle buffer can be of a size that matches the size of the individual storage unit of the corresponding set of memory components 250). The SSD controller 260 can transmit to the operating system 216 configuration information indicating the size of the individual storage unit.

The operating system 216 can then receive requests to program data from one or more of the multiple applications. The operating system 216 can cache the data locally (e.g., on DRAM) of the host system 120. The operating system 216 can maintain multiple caches each associated with a different region and/or namespace of the set of memory components 112A to 112N. For example, the operating system 216 can cache a first sequence of data (e.g., a particular arrangement of data) in association with the corresponding set of memory components 250 and can cache a second sequence of data in association with the corresponding set of memory components 252. The operating system 216 can monitor the size of the cache. In response to the operating system 216 determining that the cache reaches the size of the individual unit, the operating system 216 transmits a request to the SSD controller 260 to program the collection of data stored in the cache to the corresponding set of memory components.

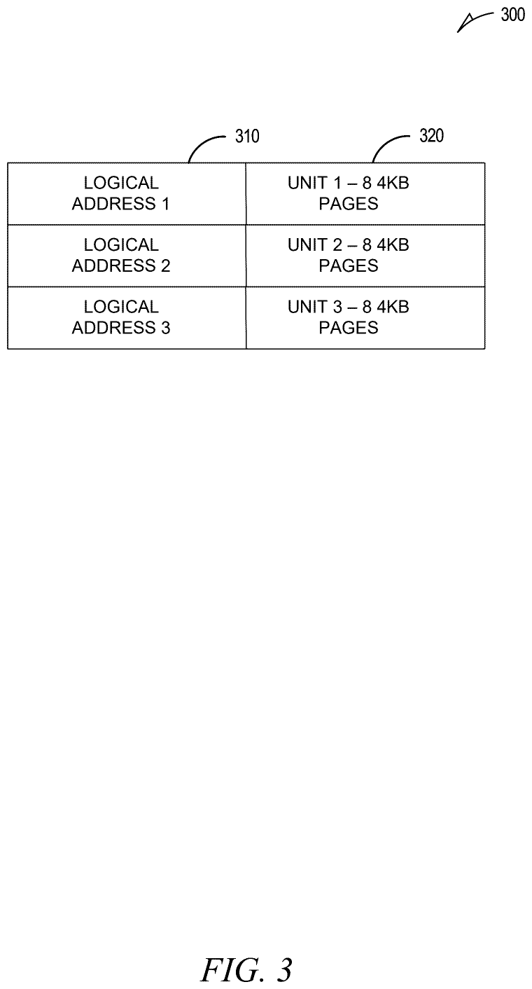

For example, the operating system 216 can continue collecting data in the first cache associated with the corresponding set of memory components 250. The operating system 216 can determine that the size of the data stored in the first cache reaches 16 KB. In response, the operating system 216 generates a request to store a collection of data including the data stored in the first cache in the particular arrangement or sequence in association with a logical block address. The request is transmitted to the SSD controller 260 and can identify the corresponding set of memory components 250 or first namespace 240. The SSD controller 260 can determine that the first namespace 240 is associated with one of two shuttle buffers 222 and 224. The SSD controller 260 determines that the set of shuttle buffers 224 is currently empty. In such cases, the SSD controller 260 associates the logical block address received in the request with a set of physical storage locations. For example, as shown in FIG. 3, the SSD controller 260 accesses a large IU table 300. The SSD controller 260 adds the logical address 310 to the large IU table 300 and associates the logical address 310 with a set of physical addresses 320 (which can include 8 4 KB pages or 4 4 KB pages).

The SSD controller 260 then places the collection of data received in the request in the shuttle buffers 224. The shuttle buffers 224 then store the collection of data directly to the corresponding set of memory components 250 at the set of physical storage locations without waiting for additional data. The data is stored in the same particular arrangement as that received from the operating system 216. This is because the collection of data received from the operating system 216 is already of a size that matches the size of the individual unit of the corresponding set of memory components 250.

In some examples, the operating system 216 transmits a request to program a set of data that is of a size that is smaller than the individual unit of the set of memory components 112A to 112N. For example, the operating system 216 can generate a request to program data that is 4 KB or less which is smaller than the individual unit of 16 KB of the corresponding set of memory components 250. The request can specify a particular logical block address that is associated in the large IU table 300 with multiple pages (e.g., 16 KB of data). In response to receiving such a request, the SSD controller 260 first retrieves a collection of data (e.g., the 16 KB of data) stored in the particular logical block address. The SSD controller 260 identifies a region or portion of the collection of data that is invalid and modifies the collection of data to store the set of data received in the request (e.g., to store the 4 KB or smaller set of data). Then, the SSD controller 260 places the collection of data back in the shuttle buffers 222 for storage in the corresponding set of memory components 250.

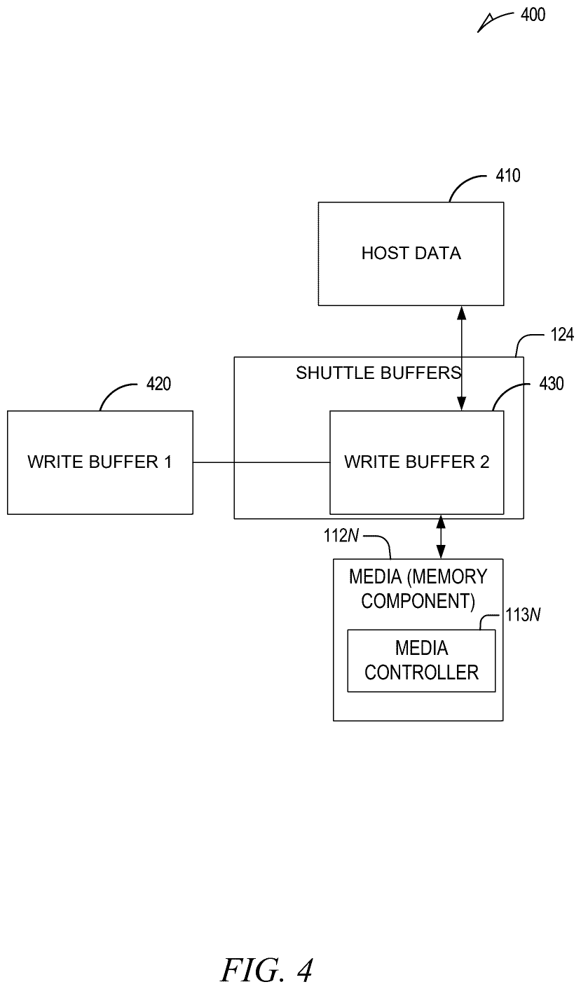

FIG. 4 is a block diagram of an example architecture 400 for a set of shuttle buffers, in accordance with some examples. The architecture 400 can include host data 410 received from the host system 120. The architecture 400 can include a first set of write buffers 420 and a second set of write buffers 430. The first set of write buffers 420 can be used in conventional systems to cache data received from the host until the data reaches a size corresponding to the individual unit size of the set of memory components 112A to 112N. For example, data received from the host can be 1 KB (or 4 KB) and can be placed in the first set of write buffers 420. Additional data can then be sequentially added to the first set of write buffers 420 until the total amount of data stored in the first set of write buffers 420 reaches the individual unit size (e.g., 8 KB, 16 KB, and so forth) of the set of memory components 112A to 112N. At that point, the SSD controller 260 transfers the data stored in the first set of write buffers 420 to the second set of write buffers 430. The second set of write buffers 430 then program the set of data to the individual unit of the set of memory components 112A to 112N.

In some examples, the host data 410 received from the host system 120 is prepackaged to be of a size that matches the size of the individual unit. In such cases, the first set of write buffers 420 can be bypassed by the SSD controller 260 and the host data 410 received from the host system 120 can be directly placed in the second set of write buffers 430 (which correspond to the one or more shuttle buffers 124). The collection of data in the second set of write buffers 430 can then be immediately or directly transferred and programmed in the set of memory components 112A to 112N. Once the set of memory components 112A to 112N confirm successful storage of the data, the host system 120 is notified by a confirm command that the collection of data was successfully stored. The host system 120 can then discard the data from the DRAM or memory of the host system 120.

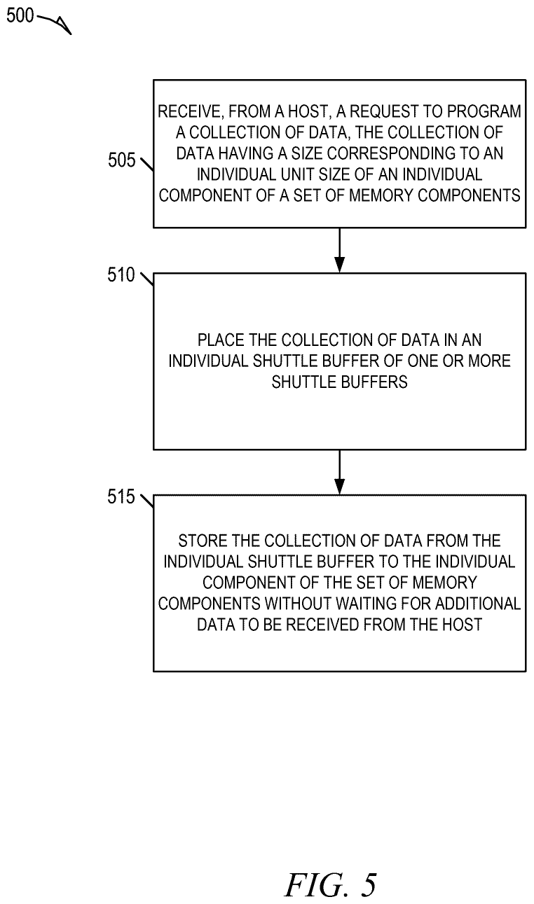

FIG. 5 is a flow diagram of an example method 500, in accordance with some examples. The method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 500 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 5, the method (or process) 500 begins at operation 505, with a media operations manager 122 of a memory sub-system (e.g., memory sub-system 110) receiving, from a host, a request to program a collection of data, the collection of data having a size corresponding to an individual unit size of an individual component of a set of memory components. Then, at operation 510, the media operations manager 122 places the collection of data in an individual shuttle buffer of one or more shuttle buffers. The media operations manager 122 stores the collection of data from the individual shuttle buffer to the individual component of the set of memory components without waiting for additional data to be received from the host at operation 515.

In view of the disclosure above, various examples are set forth below. It should be noted that one or more features of an example, taken in isolation or combination, should be considered within the disclosure of this application.

Example 1: A system comprising: a set of memory components of a memory sub-system; at least one processing device operatively coupled to the set of memory components; and one or more shuttle buffers coupled between the set of memory components and a host, the at least one processing device configured to perform operations comprising: receiving, from the host, a request to program a collection of data, the collection of data having a size corresponding to an individual unit size of an individual component of the set of memory components; placing the collection of data in an individual shuttle buffer of the one or more shuttle buffers; and storing the collection of data from the individual shuttle buffer to the individual component of the set of memory components without waiting for additional data to be received from the host.

Example 2. The system of Example 1, wherein the request is received from a first application being executed by the host that is associated with a first namespace of a plurality of namespaces.

Example 3. The system of Example 2, wherein the first namespace is associated with a first portion of a logical address space corresponding to the set of memory components, and wherein a second namespace of the plurality of namespaces is associated with a second portion of the logical address space corresponding to the set of memory components.

Example 4. The system of any one of Examples 1-3, wherein the memory sub-system comprises a solid-state drive.

Example 5. The system of any one of Examples 1-4, wherein the collection of data is programmed to the individual component using a single buffer comprising the individual shuttle buffer.

Example 6. The system of any one of Examples 1-5, the operations comprising: determining a maximum number of regions of the set of memory components that are programmable in parallel; and generating a quantity of shuttle buffers in the one or more shuttle buffers corresponding to the maximum number of regions of the set of memory components that are programmable in parallel.

Example 7. The system of any one of Examples 1-6, wherein the collection of data is received from the host in a particular arrangement, and wherein the collection of data is programmed to the individual component in the same particular arrangement.

Example 8. The system of any one of Examples 1-7, wherein the host sequentially adds portions of data associated with one or more applications to the collection of data to align the collection of data with the individual unit size of the individual component.

Example 9. The system of Example 8, wherein the host transmits the request to program the collection of data in response to determining that the collection of data has the size corresponding to the individual unit size of the individual component.

Example 10. The system of any one of Examples 1-9, wherein the individual unit size is greater than a 4 KB page size.

Example 11. The system of Example 10, wherein the individual unit size comprises 512 KB.

Example 12. The system of any one of Examples 10-11, wherein the operations comprise: maintaining a set of large indirection units (IUs); and associating, in the set of large IUs, an individual logical address received from the host with an individual unit of the individual component corresponding to the individual unit size that is greater than 4 KB.

Example 13. The system of any one of Examples 1-12, wherein the one or more shuttle buffers are implemented by SRAM or DRAM.

Example 14. The system of any one of Examples 1-13, the operations comprising: transmitting, to the host, configuration information indicating the individual unit size of the individual component that is greater than 4 KB.

Example 15. The system of any one of Examples 1-14, the operations comprising: receiving, from the host, an additional request to program a set of data; determining that the set of data is smaller than the individual unit size of the individual component; and in response to determining that the set of data is smaller than the individual unit size of the individual component, retrieving a portion of data having a size corresponding to the individual unit size of the individual component.

Example 16. The system of Example 15, the operations comprising: modifying the retrieved portion of data using the set of data to generate a new portion of data having the set of data and being of the size corresponding to the individual unit size; and storing the new portion of data to the individual component.

Example 17. The system of any one of Examples 1-16, the operations comprising: transmitting a confirmation of storage to the host in response to successfully programming the collection of data to the individual component.

Example 18. A method comprising: receiving, from a host, a request to program a collection of data, the collection of data having a size corresponding to an individual unit size of an individual component of a set of memory components; placing the collection of data in an individual shuttle buffer of one or more shuttle buffers; and storing the collection of data from the individual shuttle buffer to the individual component of the set of memory components without waiting for additional data to be received from the host.

Example 19. The method of Example 18, wherein a request is received from a first application being executed by the host that is associated with a first namespace of a plurality of namespaces.

Example 20. A non-transitory computer-readable storage medium comprising instructions that, when executed by at least one processing device, cause the at least one processing device to perform operations comprising: receiving, from a host, a request to program a collection of data, the collection of data having a size corresponding to an individual unit size of an individual component of a set of memory components; placing the collection of data in an individual shuttle buffer of one or more shuttle buffers; and storing the collection of data from the individual shuttle buffer to the individual component of the set of memory components without waiting for additional data to be received from the host.

Methods and computer-readable storage medium with instructions for performing any one of the above Examples.

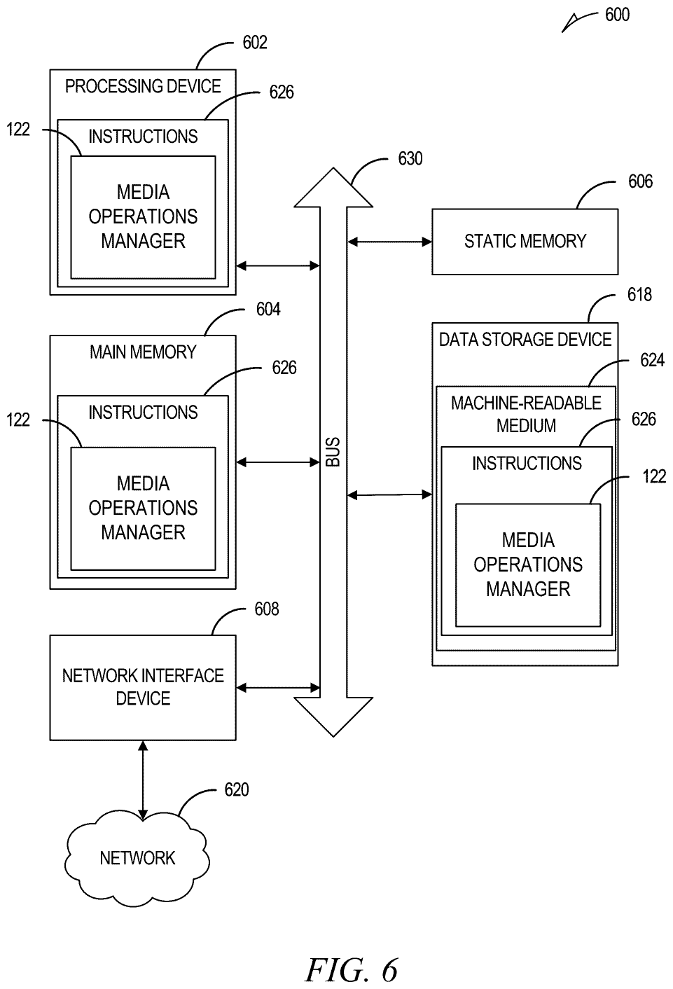

FIG. 6 illustrates an example machine in the form of a computer system 600 within which a set of instructions can be executed for causing the machine to perform any one or more of the methodologies discussed herein. In some examples, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media operations manager 122 of FIG. 1). In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., ROM, flash memory, DRAM such as SDRAM or Rambus DRAM (RDRAM), etc.), a static memory 606 (e.g., flash memory, static random access memory (SRAM), etc.), and a data storage system 618, which communicate with each other via a bus 630.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an ASIC, a FPGA, a digital signal processor (DSP), a network processor, or the like. The processing device 602 is configured to execute instructions 626 for performing the operations and steps discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one example, the instructions 626 implement functionality corresponding to the media operations manager 122 of FIG. 1. While the machine-readable storage medium 624 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; ROMs; random access memories (RAMs; EPROMS; EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine-readable (e.g., computer-readable) storage medium such as a ROM, RAM, magnetic disk storage media, optical storage media, flash memory components, and so forth.

In the foregoing specification, the disclosure has been described with reference to specific examples thereof. It will be evident that various modifications can be made thereto without departing from the broader scope of the disclosure as set forth in the following claims. The specification and drawings are, accordingly, to be regarded in an illustrative sense rather than a restrictive sense.

What is claimed is:

1. A system comprising:
a set of memory components of a memory sub-system;
at least one processing device operatively coupled to the set of memory components; and
one or more shuttle buffers coupled between the set of memory components and a host, the at least one processing device configured to perform operations comprising:
receiving, from the host, a request to program a collection of data, the collection of data having a size corresponding to an individual unit size of an individual component of the set of memory components;
placing the collection of data in an individual shuttle buffer of the one or more shuttle buffers; and
storing the collection of data from the individual shuttle buffer to the individual component of the set of memory components without waiting for additional data to be received from the host.

2. The system of claim 1, wherein the request is received from a first application being executed by the host that is associated with a first namespace of a plurality of namespaces.

3. The system of claim 2, wherein the first namespace is associated with a first portion of a logical address space corresponding to the set of memory components, and wherein a second namespace of the plurality of namespaces is associated with a second portion of the logical address space corresponding to the set of memory components.

4. The system of claim 1, wherein the memory sub-system comprises a solid-state drive.

5. The system of claim 1, wherein the collection of data is programmed directly to the individual component using a single buffer comprising the individual shuttle buffer and without passing through any other buffers.

6. The system of claim 1, the operations comprising:
determining a maximum number of regions of the set of memory components that are programmable in parallel; and
generating a quantity of shuttle buffers in the one or more shuttle buffers corresponding to the maximum number of regions of the set of memory components that are programmable in parallel.

7. The system of claim 1, wherein the collection of data is received from the host in a particular arrangement, and wherein the collection of data is programmed to the individual component in the same particular arrangement.

8. The system of claim 1, wherein the host sequentially adds portions of data associated with one or more applications to the collection of data to align the collection of data with the individual unit size of the individual component.

9. The system of claim 8, wherein the host transmits the request to program the collection of data in response to determining that the collection of data has the size corresponding to the individual unit size of the individual component.

10. The system of claim 1, wherein the individual unit size is greater than a 4 KB page size.

11. The system of claim 10, wherein the individual unit size comprises 512 KB.

12. The system of claim 10, wherein the operations comprise:
maintaining a set of large indirection units (IUs); and
associating, in the set of large IUs, an individual logical address received from the host with an individual unit of the individual component corresponding to the individual unit size that is greater than 4 KB.

13. The system of claim 1, wherein the one or more shuttle buffers are implemented by SRAM or DRAM.

14. The system of claim 1, the operations comprising:
transmitting, to the host, configuration information indicating the individual unit size of the individual component that is greater than 4 KB.

15. The system of claim 1, the operations comprising:
receiving, from the host, an additional request to program a set of data;
determining that the set of data is smaller than the individual unit size of the individual component; and
in response to determining that the set of data is smaller than the individual unit size of the individual component, retrieving a portion of data having a size corresponding to the individual unit size of the individual component.

16. The system of claim 15, the operations comprising:
modifying the retrieved portion of data using the set of data to generate a new portion of data having the set of data and being of the size corresponding to the individual unit size; and
storing the new portion of data to the individual component.

17. The system of claim 1, the operations comprising:
transmitting a confirmation of storage to the host in response to successfully programming the collection of data to the individual component.

18. A method comprising:
receiving, from a host, a request to program a collection of data, the collection of data having a size corresponding to an individual unit size of an individual component of a set of memory components;
placing the collection of data in an individual shuttle buffer of one or more shuttle buffers; and
storing the collection of data from the individual shuttle buffer to the individual component of the set of memory components without waiting for additional data to be received from the host.

19. The method of claim 18, wherein the request is received from a first application being executed by the host that is associated with a first namespace of a plurality of namespaces.

20. A non-transitory computer-readable storage medium comprising instructions that, when executed by at least one processing device, cause the at least one processing device to perform operations comprising:
receiving, from a host, a request to program a collection of data, the collection of data having a size corresponding to an individual unit size of an individual component of a set of memory components;
placing the collection of data in an individual shuttle buffer of one or more shuttle buffers; and
storing the collection of data from the individual shuttle buffer to the individual component of the set of memory components without waiting for additional data to be received from the host.
